(19) United States
(12) Patent Application Publication
(10) Pub. No.: US 2016/0104982 A1
(43) Pub. Date: Apr. 14, 2016

(54) CONNECTING DEVICE FOR ELECTRONIC APPLIANCE

(71) Applicant: Oxti Corporation, Taipei (TW)

(72) Inventor: Chih Feng HO, Taipei (TW)

(21) Appl. No.: 14/509,212

(22) Filed: Oct. 8, 2014

(51) Int. Cl. H01R 13/74; H01R 25/00; H01R 13/70

(52) U.S. Cl. CPC H01R 13/74; H01R 13/70; H01R 25/00

(57) ABSTRACT

A connecting device includes a table device having a base frame member, and a table plate disposed on the base frame member for supporting an electronic appliance, and a housing disposed in the base frame member and having a connector for connecting to a cable device, and having one or more socket members for coupling to the electronic appliances. The table device includes an opening formed in the base frame member and aligned with the connector for allowing the cable device to be electrically connected to the connector. The housing includes one or more socket elements each electrically connected to the housing with a wire.

### BACKGROUND OF THE INVENTION

1. Field of the Invention

The present invention relates to a power connecting device, and more particularly to a power connecting device including an improved structure or configuration for suitably supporting electronic appliances on a table device and for allowing the electronic appliances to be easily and quickly and readily connected or coupled to the connecting device.

2. Description of the Prior Art

Typical cable organizer or organizing or connecting devices comprise a casing or housing having a plate or wall member which includes one or more openings or orifices or notches formed therein for receiving or engaging with the wires or cables and for winding and storing and organizing the wires or cables therein and for preventing the wires or cables from being disengaged or separated from the connecting device.

For example, U.S. Pat. No. 7,098,406 to Hammonds, U.S. Pat. No. 7,446,260 to Hammonds, U.S. Pat. No. 8,076,584 to Huang et al. and U.S. Pat. No. 8,668,160 to Cheng disclose several of the typical cable organizing devices each comprising a casing or housing having a compartment or chamber or one or more openings or orifices or notches formed therein for receiving or engaging with the wires or cables and for winding and storing and organizing the wires or cables therein and for preventing the wires or cables from being disengaged or separated from the casing or housing of the connecting device.

However, the typical cable organizing devices may only be used to receive or engage with or organize the wires or cables, but may not be used to support electronic appliances, and the electronic appliances may not be easily and quickly and readily connected or coupled to the connecting device.

The present invention has arisen to mitigate and/or obviate the afore-described disadvantages of the conventional cable organizing or connecting devices.

### SUMMARY OF THE INVENTION

The primary objective of the present invention is to provide a connecting device including an improved structure or configuration for suitably supporting electronic appliances on a table device and for allowing the electronic appliances to be easily and quickly and readily connected or coupled to the connecting device.

In accordance with one aspect of the invention, there is provided a connecting device comprising a table device including a base frame member, and including a table plate provided on the base frame member for supporting an electronic appliance, and a housing disposed in the base frame member and including a plug or socket or connector for connecting to a cable device, and including at least one socket member for coupling to the electronic appliance.

The table device includes an opening formed in the base frame member and aligned with the connector for allowing the cable device to be electrically connected to the connector of the housing with a cable member.

The table device includes one or more recesses or notches formed or provided in the table plate for receiving or engaging with the cable device and for hiding or storing and organizing the cable device.

The housing includes at least one socket element electrically connected to the housing with a wire. The housing includes a switch provided thereon for controlling a supplying of an electric energy to the socket member and/or to the socket element and for switching on and off the socket member and/or the socket element.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view illustrating the operation of a connecting device in accordance with the present invention; and

FIG. 2 is a partial exploded view of the connecting device.

### DETAILED DESCRIPTION OF THE PREFERRED EMBODIMENT

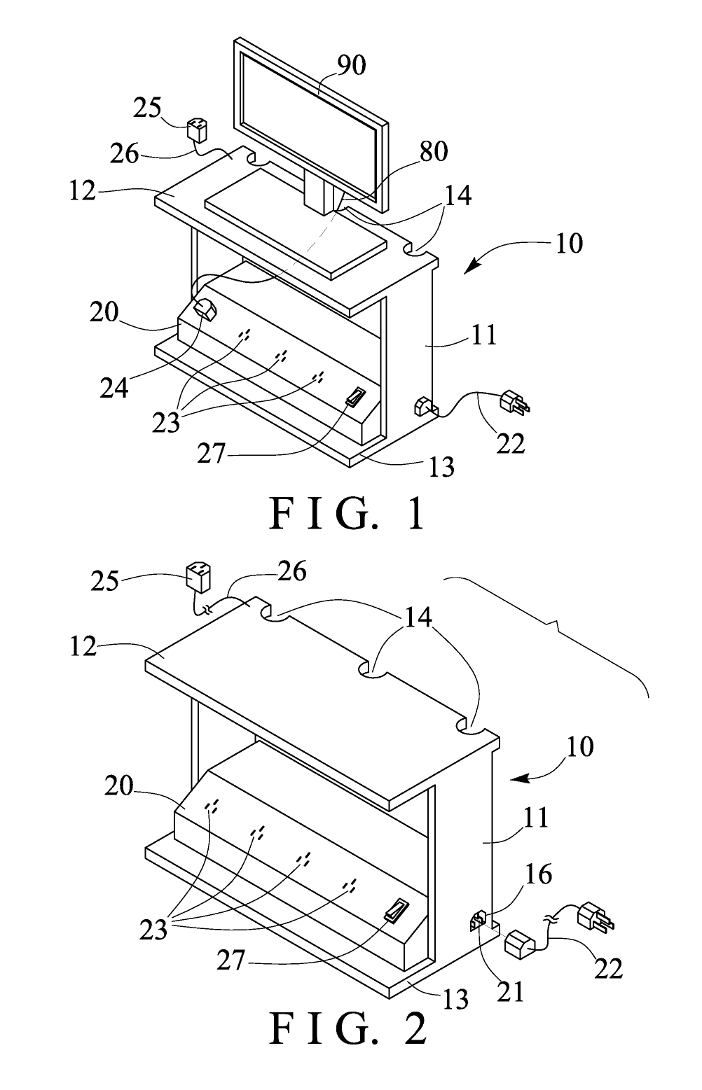

Referring to the drawings, and initially to FIG. 1, a connecting device in accordance with the present invention comprises a receptacle or housing or table device 10 (FIGS. 1, 2) including a lower or bottom portion or panel or base frame member 11, and a table plate 12 formed or provided on top of the base frame member 11, it is preferable, but not necessary that the table device 10 includes a lower or bottom panel or board 13 formed or provided on the lower or bottom portion of the base frame member 11, and includes one or more (such as three) recesses or notches 14 formed or provided in the table plate 12 for receiving or engaging with or for anchoring or retaining or positioning the wires or cables 80 or the like. The table plate 12 of the table device 10 may be provided for supporting electronic objects or articles or appliances 90, such as monitors, keyboards, antenna members, displayers 90 or the like (FIG. 1).

The connecting device further includes a receptacle or housing 20 formed or provided in or attached or mounted or secured or coupled to the lower or bottom portion of the base frame member 11 and preferably supported on the bottom board 13 of the table device 10. The housing 20 includes a socket or plug or connector 21 formed or provided thereon for connecting or coupling to a power station or power source (not illustrated) with a cable device 22 and for receiving the electricity or electric energy from the power station or power source, and includes one or more plugs or connectors or socket members 23 formed or provided thereon for connecting or coupling to the electronic appliances 90 with the cables 80 and the plugs 24, and includes one or more further plugs or connectors or socket elements 25 electrically connected or coupled to the housing 20 with cables or wires 26 for connecting or coupling to the other electronic objects or articles or appliances (not illustrated), such as monitors, keyboards, antenna members, displayers, printers, computer stations, speakers, or the other peripherals.

As shown in FIG. 2, the table device 10 may include an orifice or opening 16 formed therein, such as formed in the base frame member 11 and communicating with or aligned with the connector 21 for allowing the cable device 22 to be electrically connected or coupled to the connector 21. The housing 20 may further include a switch 27 formed or provided thereon for switching or controlling the supplying of the electricity or electric energy to the socket members 23 and/or the socket elements 25.

In operation, as shown in FIG. 1, the electronic appliance 90 may be suitably and solidly and stably supported on the table plate 12, and may be easily and quickly and readily and electrically connected or coupled to either of the socket members 23 or the socket elements 25, such that the wires or cables for the electronic appliances may be suitably received or engaged in and wound and stored and organized in the housing 20, and will not be exposed to interfere the users.

Accordingly, the connecting device in accordance with the present invention includes an improved structure or configuration for suitably supporting electronic appliances on a table device and for allowing the electronic appliances to be easily and quickly and readily connected or coupled to the connecting device.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A connecting device for electronic appliance, comprising:
a table device including a base frame member, and including a table plate provided on said base frame member for supporting the electronic appliance, and
a housing disposed in said base frame member and including a connector for connecting to a cable device, and including at least one socket member for coupling to the electronic appliance.

2. The connecting device as claimed in claim 1, wherein said table device includes an opening formed in said base frame member and aligned with said connector for allowing said cable device to be electrically connected to said connector.

3. The connecting device as claimed in claim 1, wherein said table device includes at least one notch formed in said table plate for engaging with said cable device.

4. The connecting device as claimed in claim 1, wherein said housing includes at least one socket element electrically connected to said housing with a wire.

5. The connecting device as claimed in claim 1, wherein said housing includes a switch provided thereon for controlling a supplying of an electric energy to said at least one socket member.
